(19) United States
(12) Patent Application Publication
(10) Pub. No.: US 2023/0252278 A1
(43) Pub. Date: Aug. 10, 2023

(54) PREDICTIVE MAINTENANCE GENERAL AI ENGINE AND METHOD

(71) Applicants: Leen Kweider, Doha (QA); Tareq Aljaber, Brentwood, CA (US); Omar Altamimi, Amman (JO)

(72) Inventors: Leen Kweider, Doha (QA); Tareq Aljaber, Brentwood, CA (US); Omar Altamimi, Amman (JO)

(21) Appl. No.: 17/665,543

(22) Filed: Feb. 6, 2022

(51) Int. Cl. G06N 3/08; G06N 3/04

(52) U.S. Cl. CPC G06N 3/08; G06N 3/0454

(57) ABSTRACT

Systems and methods for building predictive maintenance artificial intelligence models are disclosed that can predict machine failures in advance using the historical sensor readings and machine failure logs. The engine utilizes a variety of data science pipelines to process and model historical sensor data for both learning failure patterns to predict them and learning sensors' normal behavior to detect the abnormality when it happens. The engine is able to automatically differentiate between normal sensor signals and failure(indicators) signals, as well as artificially generate failure signals to generalize the prediction for rarely occurring failures.

### FIELD OF TECHNOLOGY

This invention pertains to the use of artificial intelligence (AI) to enable predictive maintenance. The invention, more specifically, pertains to a general method of automatically generating an AI predictive maintenance model for any machine.

### BACKGROUND OF INVENTION

Maintenance management for any type of assets or machines needs to determine whether to be a corrective or preventive maintenance strategy. These two approaches have their own benefits and drawbacks.

Corrective maintenance tries to replace parts as they fail. Corrective maintenance guarantees that system parts are used until they fail, but it comes at a cost to the organization in terms of downtime, manpower, and unscheduled repair.

Preventive maintenance seeks to prevent a failure before it occurs so the machine part is replaced before it reaches the end of its useful life to avoid a breakdown. Preventive maintenance saves money by preventing unexpected problems, but it also costs money because parts aren't used as much.

Predictive maintenance is used to overcome the disadvantages of the other two maintenance approaches; it aims to maximize the time that machine parts are in use while avoiding breakdowns. Predictive maintenance means knowing when a machine will fail, which increases productivity, decreases breakdowns, and lowers maintenance costs. Artificial intelligence (AI) is widely used as a promising solution for this problem because it can learn failure patterns from historical data and predict future ones. Most businesses have two options for developing artificial intelligence predictive maintenance models. 1) build their own purpose-built AI model by hiring 2-3 data scientists who will primarily focus on one case, one machine, and one data stream. Alternatively, they can work with a service provider/consultant, which is both expensive and time consuming. Both of these options are only available to large manufacturing firms with deep pockets. Moreover, building a predictive maintenance AI model presents additional challenges: 1) The limited number of failures which makes it hard for the AI model to generalize. 2) The lack of high-quality data; failures don't always have discriminative patterns because machines fail for a variety of reasons that aren't always consistent, which severely degrade the generalization performance of any AI model. 3) Unexpected sensor readings that occur in real time but have never occurred before, making it difficult to predict using an AI model trained on historical patterns.

Another major challenge in developing a general predictive maintenance model is that each machine has its own functionality and, as a result, its own set of sensors for detecting failures, so most existing approaches treat each problem separately.

### SUMMARY OF INVENTION

In once aspect, a method to maintain a machine includes receiving machine historical sensor data and their failure log and generating a failure labeling model to generate training data from a failure prediction window, a history window and a failure infected interval settings; providing the failure labeling model's output data to a failure classification model or pipeline that is generated automatically to learn failure signal behavior and also providing the failure labeling model's output to an anomaly detection model or pipeline to detect an abnormal behavior in real time; and applying an ensemble classifier to the outputs of the data failure classification model and the anomaly detection model to predict a machine failure.

In implementations, the method includes automatically identifying failure instances from a historical data stream by the failure labeling model. The method includes using time series similarities to relabel a failure and normal signals and increasing the quality of training data for the failure classification model or pipeline. The method includes real-time general streaming that allows businesses to link machines and assets. The method includes providing the output of the labeling model to generate quality labeled training data. The failure labeling model can be generated by labeling failure log intervals; for each failure, saving data from a predetermined time frame; deleting intersecting signals between failures and normal labels; and performing failure labeling refurbishment. The performing the failure labeling refurbishment is based on time series similarity which automatically distinguishes between normal and failure signals by using failure labeled cases as ground truth and labeling similar signals as failures. The method includes generating two-dimensional (2D) time series data with timestamps and features. The method includes generating three-dimensional (3D) time series data with timestamps, history window, and features. The method includes generating two-dimensional (2D) time series data with timestamps and features; generating features with a feature selection model; normalizing the features; and generating three-dimensional (3D) time series data with timestamps, history window, and features. The method includes providing the 3D time series data to the failure classification model and the anomaly detection model. The method includes augmenting failure data; balancing the failure data; extracting features from the data; if features are extracted, selecting a 2D learning model and otherwise selecting a 3D learning model; and performing failure prediction. The engine utilizes a general way of modelling machine lifetime and failures by three main settings: failure prediction window, history window and failure infected interval. The failure prediction window is a quantity of time that expresses the minimum time needed to perform maintenance, Infected interval is located right after the failure with the minute of failure, all data in this interval should not be used for training or evaluation because it contains unusual data due to breakdown, maintenance or restart procedures and History window is the quantity of time to look back at each instance. The engine utilizes a combined way of modeling the problem using data science pipeline; and the failure classification pipeline is generated automatically to learn failure signals behavior and the anomaly detection pipeline that is used to detect the abnormal behavior in real time. The engine utilizes a general way of automatically identifying the failure instances from historical data stream by the Failure Labeling Module that uses time series similarities to relabel the failure and normal signals which increase the quality of the data that the failure classification model will train on. The engine includes a real-time general streaming module that allows businesses to link their machines assets, and related IoT readers using an intuitive and easy to use general connectivity layer to the PDM model for real-time monitoring of failure alarms.

Advantages of the system may include one or more of the following. The system includes a generalized engine and method of building predictive maintenance AI models that can anticipate machine failures in real time. The engine is tailored towards reliability and operations engineers who have no prior experience in data science. The engine is sensor and machine agnostic where it can connect and work with any type of machine using historical sensor readings and machine failure logs. The engine utilizes a variety of data science advanced pipelines to process and model historical sensor data, including the ability to automatically distinguish between normal sensor signals and failure(indicators) signals, as well as artificially generate failure signals to generalize the prediction for rarely occurring failures. The system generally provides predictive maintenance and machine failure prediction in advance, and the engine can be used by any performance or reliability engineer with no prior data science knowledge to upload their machine's historical data and their failure log and auto generate an AI predictive model for them that can be deployed and connected live in production. The engine overcomes the lack of failures problem using a general way of artificially generating machine failures in order for the AI engine to generalize.

### BRIEF DESCRIPTION OF THE DRAWINGS

The invention is described in accordance with the aspects and embodiments in the following description with reference to the figures, in which like numbers represent the same or similar elements, as follows:

FIG. 1 shows an exemplary Flowchart of the General Predictive Maintenance full system in accordance with the invention.

FIG. 2 shows an exemplary Flowchart of the Failure Labeling Module steps of the Predictive Maintenance General Engine while FIG. 3 shows an exemplary Flowchart of the General Predictive Maintenance Data Science Engine as part of the full system.

FIG. 4 shows an exemplary Flowchart of how a Failure Classification Pipeline is built and steps of the Predictive Maintenance General Engine.

FIG. 5 shows an exemplary Flowchart of the operation of deploying an AI model created by the Predictive Maintenance General Engine using the General Real Time Streaming module.

### DETAILED DESCRIPTION

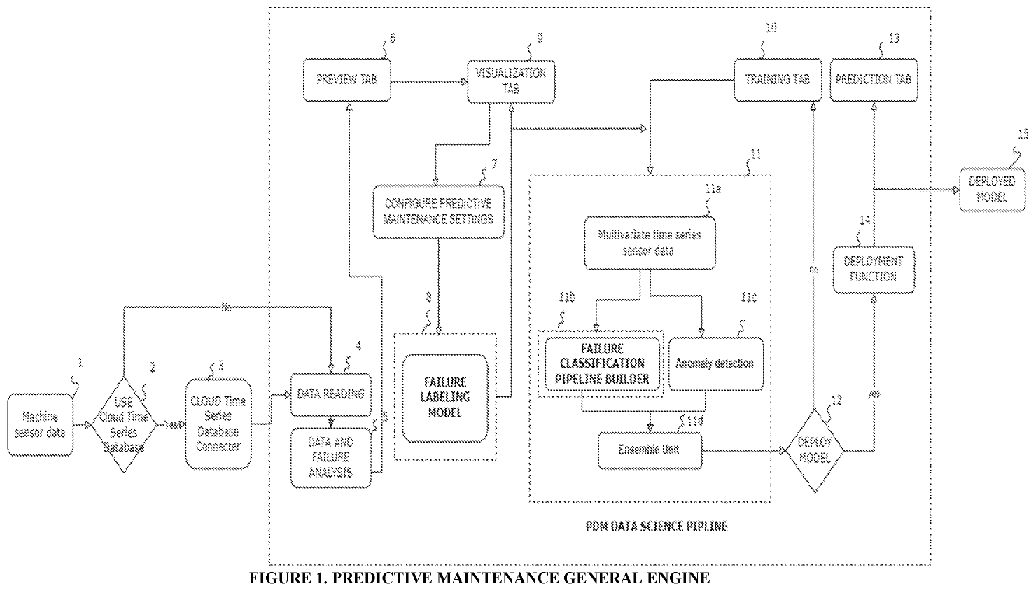

FIG. 1 shows an exemplary PREDICTIVE MAINTENANCE GENERAL ENGINE (PDM Engine) that can be used by any performance or reliability engineer with no prior data science knowledge to upload their machine's historical data and their failure log and auto generate an AI predictive model for them that can be deployed and connected live in production.

As shown in FIG. 1, the PDM Engine consists of five main components, namely a data reading module, a failure labeling module, a data science pipeline which contains both classification pipeline builder and an anomaly detection pipeline with ensemble unit between both of them and a deployment module that connect real time streaming module for machine real time failure predictions.

The inputs to the engine are historical machine sensor readings containing time-series data and the failure log for these machines, and the output of the engine is a predictive maintenance AI model trained on historical failure patterns to be connected in production and get the failure alarms in real time when the model predicts a failure in advance.

Data Reading 4: As the first step in the process, the data will be read from the company's machine historical sensor readings. The user can either connect with cloud time series databases TSDB 2 or have the data files loaded directly. The Engine is able to ingest data in any one of multiple data formats supported including, for example, .csv, .xls, .xlsx file formats with sensors reading as columns and one failure column containing the state of the machine history at that time and operational settings.

Time series database (TSDB) or data historian is data that contains historical sensor readings; A time series database is any database that is particularly well suited for handling time series data (e.g., digital sensor readings), A data historian is a software program that records the data of processes running in a computer system. Organizations use data historians to gather information about the operation of machines.

Once the data is imported into the Data Reading block 4, the data first undergo a Data And Failure Analysis Function 5 to analysis the signals and failures to give statistical information about sensor readings in the Preview Tab 6 as well dynamic failure signals filtering to visualize interactively in the Visualization Tab 9.

In FIG. 1, in the visualization tab, the user should configure the predictive maintenance three main settings: the failure prediction window, history window and failure infected interval; A Failure Prediction Window is a period of time that needed to perform maintenance, Infected Interval Window is the amount of time that the machine remained down after failure or was being maintained in the provided data History Window is the period of time that model should look back when analyzing sensor signals.

Note that in this document the terms user and company are terms with similar but different meanings. For the purposes of this document, a user is for example a performance engineer or reliability manager who wants to use the system to generate a predictive model for his company's machine that he is monitoring. A company is defined as the receiving end of a service which owns the machines that need to be maintained before the failure.

After choosing these PDM settings that are used to model the target machine lifetime and its failures the data is fed to the Failure Labeling Module 8 which is the most important criteria to refine the data and its failures so the AI model can learn the differences between normal operational sensor signals and the failure ones. The output of this module is the same sensor data stream but with clean failure labels.

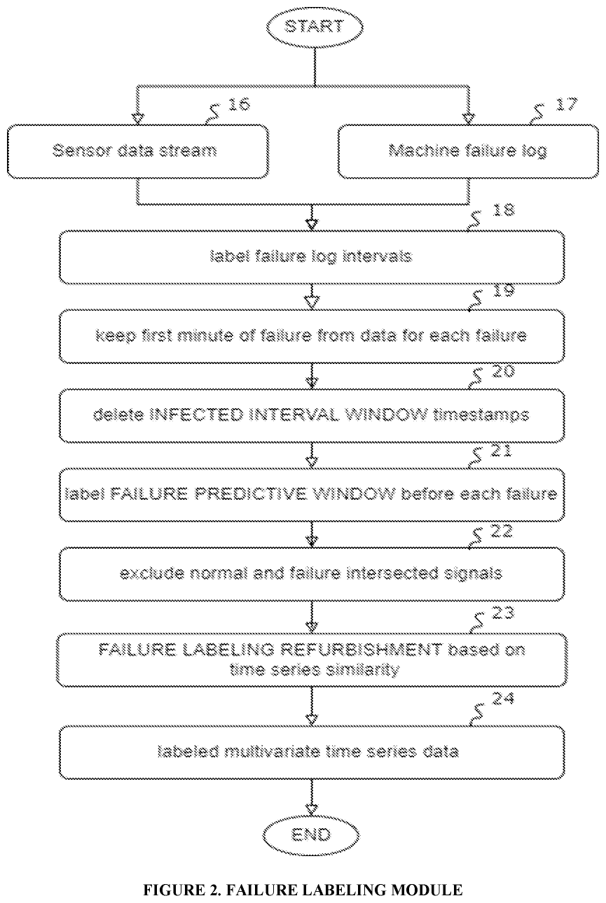

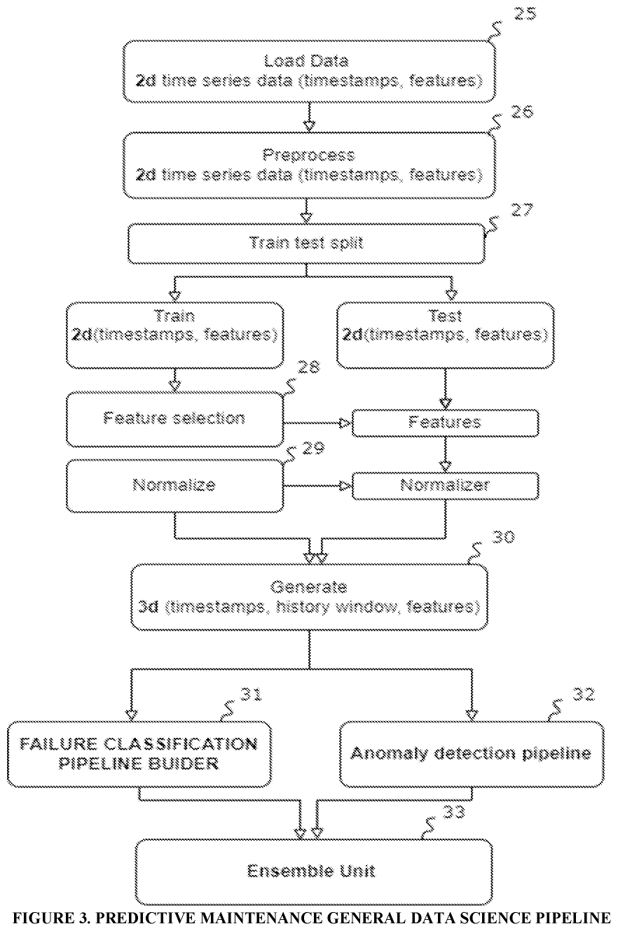

In FIG. 2, the Failure Labeling Module is the part of the engine that takes as input 1) PDM configuration settings 2) sensor readings 3) and machine failure log, and labels the data based on these settings with the failure log intervals; firstly by keeping first minute of failure for each failure 19, removing infected interval window from sensor streams 20 so the AI model will ignore machine failure downtime, and instead label failure prediction window before each failure 21 allowing the AI model to consider a window before failure as failures too. However, because this predictive window is a hyper parameter to the PDM engine that varies from machine to machine, treating it as a fixed period for all failures will not reflect reality, as each failure may occur at different times. The next step is to delete the intersected signals between failures and normal labels 22 and perform failure labeling refurbishment based on time series similarity 23 which automatically distinguishes between normal and failure signals by using failure labeled cases as ground truth and labeling similar signals as failures, and vice versa.

Consider training time series data X=x0, x1, . . . , xn as input to failure labeling model with f failures, where n is the number of all instances and each instance has m features (sensor operational readings), and let pw be the predictive window before each failure; the failure labeling model is labeling all instances from [xn−pw: xn] as failures before each failure, then the failure labeling model is performing label refurbishment by:
Assuming XF=[x1, x2, . . . , xf], XF are failure cases from all the failure-labeled predictive windows.
Assuming XNO=[x1, x2, . . . , xno], where XN are normal instances with no failure in the time span −pw, +pw for each x. (normal instances that are not related to failures).
Deleting any instances that contain sequences intersecting from the two sets XF and XNO.
Labeling any remaining examples from the training data that do not belong to XF and XNO as failure or normal using the DTW dynamic temporal warping similarity measurement.

In FIG. 1, after the Failure Labeling Module labeled the failures in the right way the data will be ready to enter the data science pipeline engine 11 in the Training Tab 10 which is described in FIG. 3, where the sensor data is loaded in 2d multivariate time series format, processed and cleaned from corrupted streams, Feature Selection 28 and Normalization 29; this automates the elimination of sensor columns that don't contain significant information, and avoid hidden biases in the model, speeding up data processing, reducing model training time, and improving performance, then this 2d time series data is converted into 3d sequences data using the Generate sequence function 30 taking the History window parameter as context when generating sequences.

The 3d time series data is then fed into two pipelines; the deep learning failure classification pipeline 31 and the anomaly detection pipeline 32 The first one is to learn failure patterns from sensors and can predict when the target machine behaves the same as previous failures and the second one is to learn the normal behavior of the machine and detect the abnormal signals that didn't happen in the past. The Ensemble Unit 33 then takes the prediction from both models and combines their prediction to ensure a more generalized way of handling all real cases.

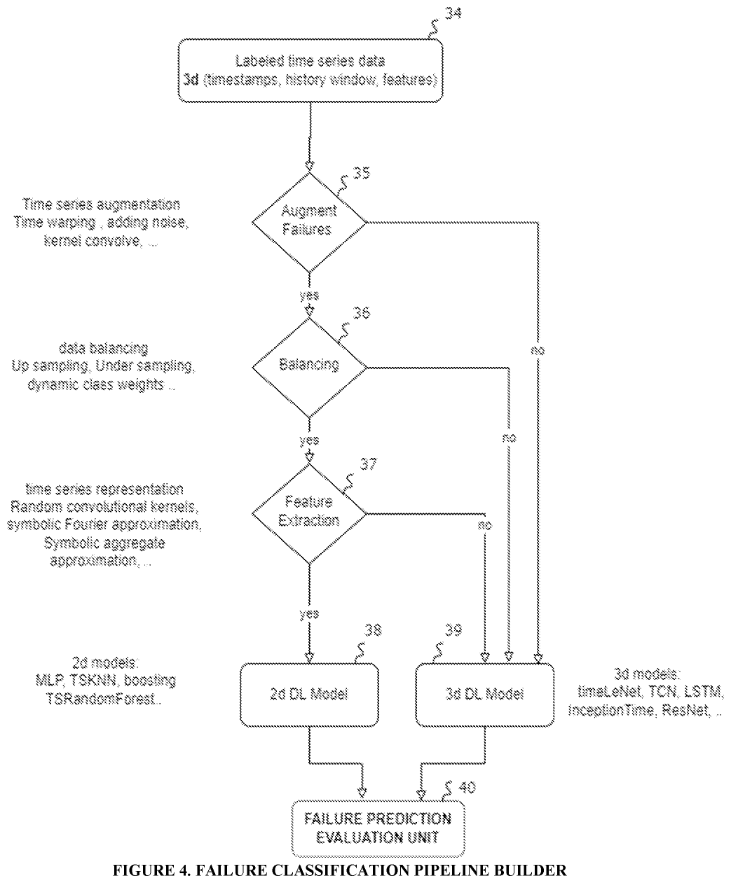

In FIG. 4, the Failure classification pipeline builder is the part of the engine where the deep learning model is auto generated to learn failure indicator patterns and predict the failure in advance, the input of this pipeline builder is the sensor data stream in 3d format (timestamps, history window, features) and the output is the best pipeline that fits the data to predict failures.

Since in the predictive maintenance problem, machines always have a limited number of failures in comparison to the normal state, deep learning models frequently treat the limited class as an outlier, so in this invention, we choose to handle this problem by automatically expanding failure signals using time series augmentation methods (Augment Failures 35) and applying various balancing methods (Balancing 36), these steps are automatically chosen by the pipeline builder based on the best performance pipeline.

Another step that is performed automatically is the Feature Extraction step 37, which takes time series signals and represents them in various ways in order to extract characteristics from data that contain the most important information in order to solve the classification problem, such as converting time data to the frequency domain and extracting its main characteristics. This step produces a two-dimensional data representation. This is then fed into the deep learning 2d models architecture type 38, or one of the 3d deep learning models architecture 39 if the pipeline builder opted not to execute the feature extraction step.

The Failure Classification Pipeline Builder builds the best pipeline to classify normal and failure signals using the Evaluation metrics that are designed custom for this problem FAILURE PREDICTION EVALUATION UNIT 40 that calculate the Failure detection rate and False alarm rate.

Failure detection rate (FDR) and false alarm rate (FAR) are used in anomaly detection and failure detection domains to evaluate the classification model performance; Failure Detection Rate is the same as True Positive Rate (Recall), which is TP/(TP+FN) and False Alarm Rate is the same as the False Positive Rate—FP/(FP+TN).

The test is applied on part of data Testing data that the model hasn't seen in the training; If a predicted value “Failure” is obtained within a fixed period previous to the failure (Predictive window), the detection is true positive; otherwise, it is false positive. If a model successfully predicts an event with a lead-time no longer than a predefined window (Predictive window), the recall value equals one; larger lead-times are regarded as false positives; otherwise, the recall value equals zero.

After the auto generated classification model and the anomaly detection model are combined together using the ensemble unit the final model is ready for deployment using the Deployment Function 14 or direct prediction in the Prediction Tab 13. Direct prediction enables the user to run multiple tests on other historical data files to similar machines to ensure the engine is working properly.

If the user decides to put the model into production, the deployment function creates deployment dependencies for it, allowing direct inference through endpoints.

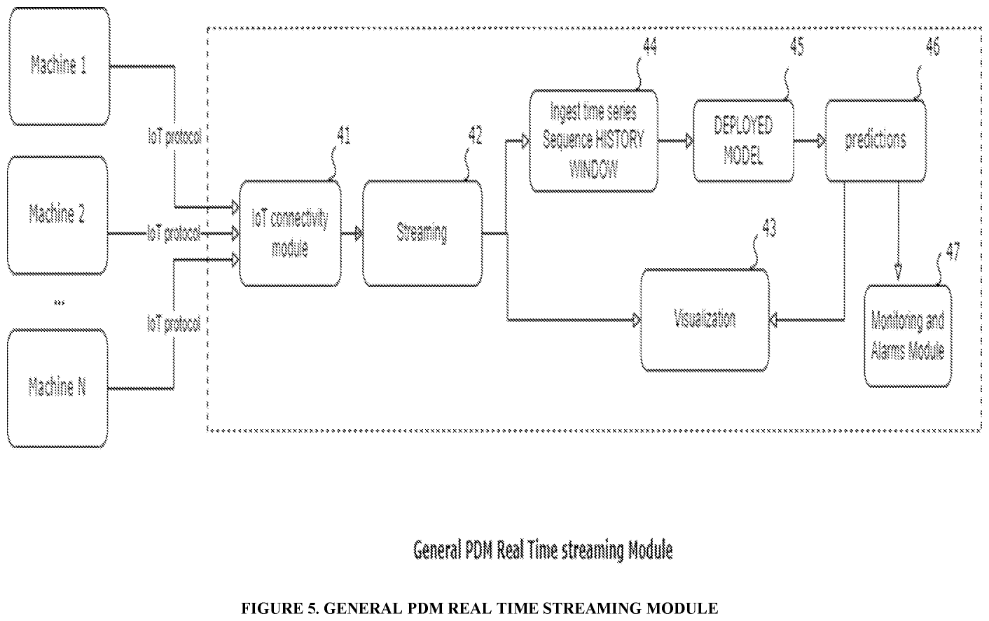

As shown in FIG. 5, the full operation of deploying the AI predictive maintenance model in production is shown, where the deployed model can be connected with multiple machine through the general IoT connectivity module 41 using different supported IoT protocols such as Modbus, MQTT, CoAP, HTTP or AMQP to easily integrate with real time sensor data from IoT devices and then the streaming layer that consists of a broker to publish the streamed data to both 1) the deployed model using the ingestion service 44 that integrates and aggregates the streamed data to shape the data in the form the model can predict and 2) to the visualization 43 to enable the user to visualize real time streamed signals. and then to the ingestion, then the real time predictions 46 also fed into 1) the visualization 43 to visualize the real time failure probability signals and into 2) the Monitoring and alarms 47 module to send the failure alarms.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature. The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments where tasks are performed by remote processing devices that are linked through a communications network. However, some, if not all aspects of this disclosure can be practiced on stand-alone computers. In a distributed computing environment, program modules can be located in both local and remote memory storage devices. As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system. In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art. As it is employed in the subject specification, the term “processor” can refer to substantially any computing processing unit or device including, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components including a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems, computer program products and computer-implemented methods. It is, of course, not possible to describe every conceivable combination of components, products and/or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method to maintain a machine, comprising:
receiving machine historical sensor data and their failure log and generating a failure labeling model to generate training data from a failure prediction window, a history window and a failure infected interval settings;
providing the failure labeling model's output data to a failure classification model or pipeline that is generated automatically to learn failure signal behavior and also providing the failure labeling model's output to an anomaly detection model or pipeline to detect an abnormal behavior in real time; and
applying an ensemble classifier to the outputs of the data failure classification model and the anomaly detection model to predict a machine failure.

2. The method of claim 1, comprising automatically identifying failure instances from a historical data stream by the failure labeling model

3. The method of claim 2, comprising using time series similarities to relabel a failure and normal signals and increasing the quality of training data for the failure classification model or pipeline.

4. The method of claim 1, comprising real-time general streaming that allows businesses to link machines and assets.

5. The method of claim 1, comprising providing the output of the failure labeling model to generate quality labeled training data.

6. The method of claim 1, wherein the failure labeling model comprises
labeling failure log intervals;
for each failure, saving data from a predetermined time frame;
deleting intersecting signals between failures and normal labels; and
performing failure labeling refurbishment.

7. The method of claim 6, wherein the performing the failure labeling refurbishment is based on time series similarity which automatically distinguishes between normal and failure signals by using failure labeled cases as ground truth and labeling similar signals as failures.

8. The method of claim 6, wherein the failure labeling model marks all instances from [xn−pw: xn] as failures before each failure, then the failure labeling model performs label refurbishment by:
a. selecting XF=[x1, x2, . . . , xf], XF are failure cases from all the failure-labeled predictive windows;
b. selecting XNO=[x1, x2, . . . , xno], where XN are Normal instances with no failure in the time span −pw, +pw for each x as normal instances unrelated to failures;
c. deleting any instances that contain sequences intersecting from the two sets XF and XNO; and
d. labeling remaining examples from training data that do not belong to XF and XNO as failure or normal using a DTW (Dynamic temporal warping) similarity measurement.

9. The method of claim 1, comprising representing machine sensor data as two dimensional (2D) time series data with timestamps and features.

10. The method of claim 1, comprising representing machine sensor data as three-dimensional (3D) time series data sequences with timestamps, history window, and features to capture temporal context.

11. The method of claim 1, comprising:
generating two-dimensional (2D) time series data with timestamps and features;
decrease number of features with a feature selection model;
normalizing the features; and
generating three-dimensional (3D) time series data with timestamps, history window, and features.

12. The method of claim 11, comprising providing the 3D time series data to the failure classification model and the anomaly detection model.

13. The method of claim 1, comprising:
augmenting failure data;
balancing the failure data;
extracting features from the data;
if features are extracted, selecting a 2D deep learning model and otherwise selecting a 3D deep learning model; and
performing failure prediction.

14. The method of claim 1, comprising generating anomaly detection model from failure labeling model output selecting normal instances training data to learn how to auto encode normal signals and performing abnormality detection to the sensor data stream.

15. The method of claim 1, comprising applying time series augmentation methods to artificially generate failure sequences when small number of failure events occurred in training data.

16. A system, comprising:
at least a machine to be maintained;
a maintenance server coupled to the machine using an internet of things (IoT) protocol in real time as a stream of data, the maintenance server running computer code for:
receiving machine historical sensor data and their failure log and generating a failure labeling model to generate training data from a failure prediction window, a history window and a failure infected interval settings;
providing the failure labeling model's output data to a failure classification model or pipeline that is generated automatically to learn failure signal behavior and also providing the failure labeling model's output to an anomaly detection model or pipeline to detect an abnormal behavior in real time; and
applying an ensemble classifier to the outputs of the data failure classification model and the anomaly detection model to predict a machine failure.

17. The system of claim 16, comprising code for automatically identifying failure instances from a historical data stream by the failure labeling model

18. The system of claim 16, comprising code for using time series similarities to relabel a failure and normal signals and increasing the quality of training data for the failure classification model or pipeline.

19. The system of claim 16, comprising code for real-time general streaming that allows businesses to link machines and assets.

20. The system of claim 16, comprising code for providing the output of the failure labeling model to generate quality labeled training data.

21. The system of claim 16, comprising code for:
augmenting failure data;
balancing the failure data;
extracting features from the data;
if features are extracted, selecting a 2D learning model and otherwise selecting a 3D learning model; and
performing failure prediction.
